(19) United States
(12) Patent Application Publication
(10) Pub. No.: US 2025/0139330 A1
(43) Pub. Date: May 1, 2025

(54) METHOD TO PREDICT SEALING PERFORMANCE OF SEALED JOINTS

(71) Applicant: FCA US LLC, Auburn Hills, MI (US)

(72) Inventor: Wensheng Zhang, Rochester Hills, MI (US)

(21) Appl. No.: 18/494,043

(22) Filed: Oct. 25, 2023

(51) Int. Cl. G06F 30/23; G06F 30/15; G06F 119/02

(52) U.S. Cl. CPC G06F 30/23; G06F 30/15; G06F 2119/02

(57) ABSTRACT

A method for determining the predicting sealing performance of a joint having a sealant positioned between a first member and a second member. The method includes selecting a sealant material for the sealant, selecting a first member material for the first member and a second member material for the second member, and subjecting the joint, using finite elemental analysis (FEA), to high cycle loads and low cycle loads. After subjecting the joint to the high cycle loads and the low cycle loads, the method includes determining a maximum high cycle displacement of the joint and determining a maximum low cycle displacement of the joint, and determining an estimated life of the joint using the following formula (1):

$$( maximum low cycle displacement + 1 ) \times ( \frac{maximum high cycle displacement}{2} ) = C \cdot {( 2 {N}_{f} )}^{2 b} ,$$

where in formula (1) C represents a constant of the sealant material, N_{f} represents the estimated life of the joint, and b represents a slope.

### FIELD

The present disclosure relates to a method to predict sealing performance of a sealed joint.

### BACKGROUND

This section provides background information related to the present disclosure which is not necessarily prior art.

Vehicles may include a number of components such as battery pack enclosures, electric drive modules, power inverter modules, transmission housings, differential casings, oil pans, and the like. During the life of the vehicle, these components will experience various loads including low cycle loads and high cycle loads. Low cycle loads experienced by the components include temperature changes, pressure changes, abnormal acceleration and/or deceleration of the vehicle, and the like. High cycle loads experienced by the components include, for example, vibrational loads that result from operation of the vehicle including vibrations generated by an engine of the vehicle and road conditions. In addition, these loads can be experienced simultaneously. When the component includes a sealant that prevents the ingress of moisture or dust into the component or prevents the egress of a liquid or fluid stored in the component, these loads can act on the sealant and can affect its useful life (e.g., cause the sealant to prematurely fail).

Conventional methods to mitigate the low and high cycle loads affecting performance of the sealant typically only address either the low cycle loads or the high cycle loads, which can result in a sealed joint that is either under-designed or over-designed. If the sealed joint is under-designed, the sealant may fail earlier than expected. If the sealed joint is over-designed, the component may have an unnecessary increase in mass that results from unnecessary extra structural stiffness (e.g., the use of more fasteners than is necessary). Accordingly, it is desirable to provide a method for predicting performance of the sealant that can assist in designing the components and provide a sealing structure that does not fail prematurely.

### SUMMARY

This section provides a general summary of the disclosure and is not a comprehensive disclosure of its full scope or all of its features.

According to an aspect of the present disclosure, there is provided a method for determining the predicting sealing performance of a joint having a sealant positioned between a first member and a second member, the method may include selecting a sealant material for the sealant, and determining fatigue constants of the sealant; selecting a first member material for the first member and a second member material for the second member; subjecting the joint, using finite elemental analysis (FEA), to high cycle loads and low cycle loads; after subjecting the joint to the high cycle loads and the low cycle loads, determining a maximum high cycle displacement of the joint and determining a maximum low cycle displacement of the joint; and determining an estimated life of the joint using the following formula (1):

$$( maximum low cycle displacement + 1 ) \times ( \frac{maximum high cycle displacement}{2} ) = C \cdot {( 2 {N}_{f} )}^{2 b} ,$$

where in formula (1) C represents a constant of the sealant material; N_{f} represents the estimated life of the joint; and b represents a slope.

According to the aspect, the high cycle loads include vibrational loads that are applied to the joint that result from operation of a vehicle including vibrations generated by an engine of the vehicle and road conditions.

According to the aspect, the low cycle loads include loads applied to the joint that result from changes in temperature, changes in pressure, and abnormal acceleration and/or deceleration of the vehicle.

According to the aspect, the method may also include changing at least one of the first member material and the second member material to another material to form a modified joint, and subjecting the modified joint, using the FEA, to the high cycle loads and the low cycle loads.

According to the aspect, the method may also include calculating a log of the product

$$( maximum low cycle displacement + 1 ) \times ( \frac{maximum high cycle displacement}{2} )$$

for each of the joint and the modified joint; calculating a log of N_{f} for each of the joint and the modified joint, and graphing the logs of the products versus the logs of N_{f} to determine the slope b.

According to the aspect, the constant C is equivalent to

$$\frac{{( {σ}_{f}^{′} )}^{2}}{E}$$

where σ_{f}′ is a fatigue strength coefficient of the sealant and E is a modulus of elasticity of the sealant.

According to the aspect, the sealant material is a one-component silicone that makes use of moisture in the atmosphere to cure the sealant or a two-component silicone that uses moisture in the atmosphere as well as a cross-linking agent such an alkoxy, acetoxy, amine, octoate, or ketoxime to cure the sealant.

According to the aspect, the first member material is a metal material or a polymeric material.

According to the aspect, the second member material is a metal material or a polymeric material.

According to the aspect, the metal material is either steel or aluminum.

According to the aspect, the polymeric material is one selected from the group consisting of polyamide, polystyrene, polypropylene, and polyethylene.

According to the aspect, the metal material is either steel or aluminum.

According to the aspect, the polymeric material is one selected from the group consisting of polyamide, polystyrene, polypropylene, and polyethylene.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a joint according to a principle of the present disclosure;

FIG. 2 is a cross-sectional view of the joint shown in FIG. 1;

FIG. 3 graphically represents various low and high cycle loads that can be applied to the joint illustrated in FIG. 1;

FIG. 4 graphically represents the number of cycles to failure when subjecting a sealant to tensile testing;

FIG. 5 graphically represents the number of cycles to failure when subjecting a sealant to shear testing;

FIG. 6 graphically illustrates the maximum displacements of the sealant when being subjected to tensile and shear testing;

FIG. 7 illustrates the plastic, elastic, and total strain fatigue curves for the sealant that are determined during tensile and shea testing; and

FIG. 8 graphically represents test results for various joints according to a principle of the present disclosure.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

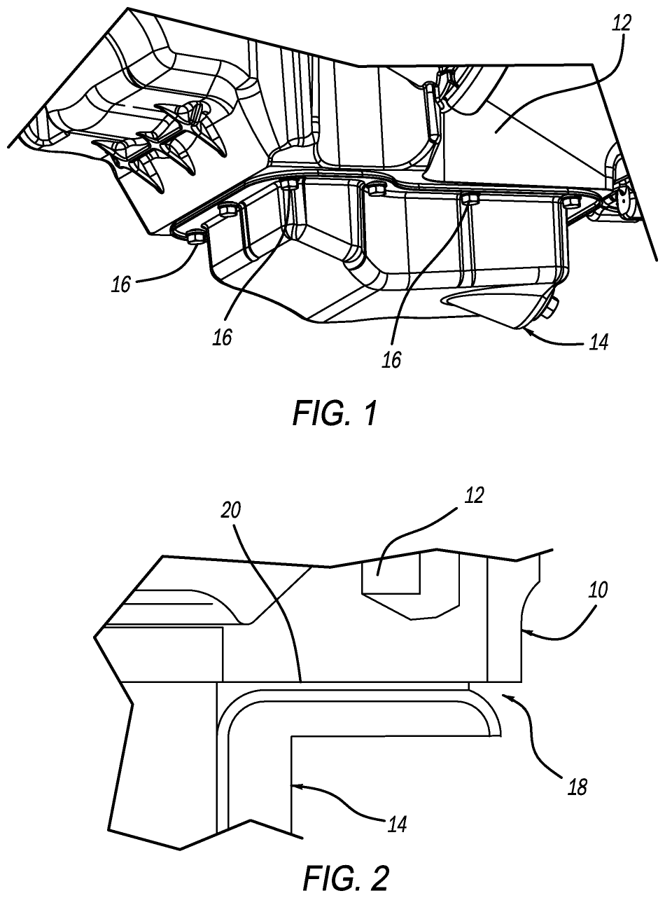

An example vehicle component 10 is illustrated in FIGS. 1 and 2 where a casing 12 is sealed using a cover 14 that is fixed to the casing 12 using a plurality of fasteners 16. While the use of fasteners 16 to fix the cover 14 relative to the casing 12 can provide a sealed joint 18 between the cover 14 and the casing 12, a sealant 20 may also be positioned between the cover 14 and the casing 12 (FIG. 2) to provide additional sealing performance relative to the ingress of gases, liquids, and particulate matter (e.g., dirt), as well as relative to the egress of a gas or liquid if the component 10 is configured to store a gas or liquid therein. An example sealant 20 is a material that can be cured using room temperature vulcanization (RTV). Example materials that can be cured using RTV include silicone materials, which may be a one-component silicone that makes use of moisture in the atmosphere to cure the sealant 20 or a two-component silicone that uses moisture in the atmosphere as well as a cross-linking agent such an alkoxy, acetoxy, amine, octoate, or ketoxime to cure the sealant 20. Other RTV sealants can be used, as are known by one skilled in the art.

During the life of the vehicle, as noted above, component 10 will experience various loads including low cycle loads and high cycle loads. Low cycle loads experienced by component 10 result from changes in temperature, changes in pressure, abnormal acceleration and/or deceleration of the vehicle, and the like. High cycle loads experienced by component 10 include, for example, vibrational loads that result from operation of the vehicle including vibrations generated by an engine of the vehicle and road conditions. In addition, these loads can be experienced simultaneously. Regardless whether the loads experienced by component 10 are low cycle or high cycle, the loads can cause cover 14 to move relative to casing 12 in the z-direction (i.e., tension displacement) as well as in the XY plane (shear displacement). These displacements between cover 14 and casing 12, which can be calculated using finite elemental analysis (FEA), can stress the sealant 20 and over time may cause cracking of sealant 20, which can affect the integrity of sealant 20.

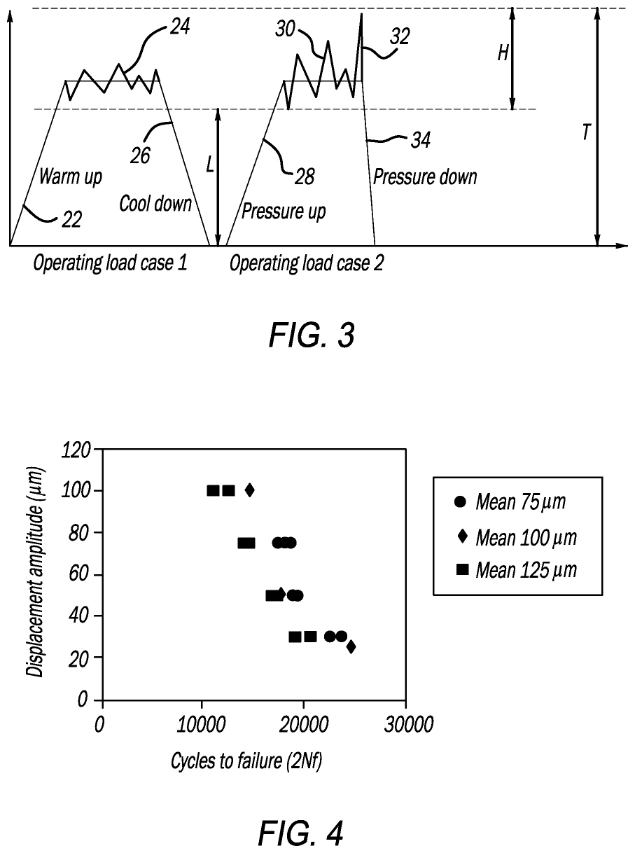

Example loads are illustrated in FIG. 3. In the example operating load case 1, the component 10 experiences a low cycle load 22 as the component 10 warms up, high cycle loads 24 during operation of the vehicle, and a low cycle load 26 as cools down component 10 cools down. In the example operating load case 2, the component experiences a low cycle load 28 as the component 10 experiences an increase in pressure, high cycle loads 30 and 32 during operation of the vehicle and the vehicle experiencing road profile loads, respectively, and a low cycle load 34 as the component 10 experiences a decrease in pressure.

In the past, to prevent displacement between the cover 14 and the casing 12, the component 10 was designed to have an increased number of fasteners 16 or change a stiffness of the structure of the joint 18. These previous methods, however, would either utilize the maximum displacement H (FIG. 3) under the high cycle loads 24, 30, and 32 or the maximum displacement L (FIG. 3) under the low cycle loads 22, 26, 28, and 34 and the high cycle loads 24, 30, and 32 to evaluate the design of component 10. Using only the maximum displacement H to validate the design of component 10 will result in an under-designed component 10 because the design does not take the low cycle loads 22, 26, 28, and 34 into consideration during the design process. Similarly, only taking into consideration the low cycle loads 22, 26, 28, and 34 into consideration will result in a design for component 10 that is over-designed and has unnecessary mass from the extra structural stiffness and/or the additional fasteners 16 since the low cycle loads 22, 26, 28, and 34 need to meet the life requirements under high cycle loads. The below Table 1 shows the typical steps employed, using FEA, to validate a joint 18 design that only uses the high cycle loads (i.e., the maximum displacement H shown in FIG. 3).

TABLE 1

| | |
|---|---|
| Step 1 | Assembly Loads |
| Step 2 | Drive Loads (acceleration and deceleration) |
| Step 3 | Drive Loads (coasting at constant velocity (e.g., 55 mph) |

With the above in mind, the present disclosure provides an improved method for determining sealing performance of joint 18. Specifically, the present disclosure determines an estimated sealing performance of different joint designs using both low cycle loads (L) and high cycle loads (H) (i.e., the maximum motion under low cycle loads and high cycle loads T in FIG. 3), as shown in the below Table 2. The different joint designs can use different types of sealants 20 (e.g., either a one-component silicone that makes use of moisture in the atmosphere to cure the sealant 20 or a two-component silicone that uses moisture in the atmosphere as well as a cross-linking agent such an alkoxy, acetoxy, amine, octoate, or ketoxime to cure the sealant 20), a greater or lesser number of fasteners 16, and different materials for the casing 12 and cover 14. For example, casing 12 may be formed of a metal material and cover 14 can be formed of a polymeric material or vice versa, or each of casing 12 and cover 14 can be formed of a metal or a polymeric material. In addition, different types of polymeric materials (e.g., polyamide, polystyrene, polyethylene, etc.) or different types of metal materials (e.g., steel, aluminum, titanium, etc.) can be used in each of the above combinations for casing 12 and cover 14.

TABLE 2

| | |
|---|---|
| Step 1 | Assembly Loads (high cycle) |
| Step 2 | Thermal Loads (low cycle) |
| Step 3 | Pressure in the System (low cycle) |
| Step 4 | Drive Loads (acceleration and deceleration) |
| Step 5 | Drive Loads (coasting at constant velocity (e.g., 55 mph) |
| Step 6 | Loads experienced at −40 degrees C. (low cycle) |

Once the low cycle load (L) and high cycle load (H) values are calculated using FEA for each of the different joint designs, an estimated life of the different joint designs can be calculated using the following formula (1):

$$( maximum low cycle displacement + 1 ) \times ( \frac{maximum high cycle displacement}{2} ) = C \cdot {( 2 {N}_{f} )}^{2 b} .$$

In the above formula, the maximum low cycle displacement (L) that is a constant displacement, the maximum high cycle displacement (H) that is a cyclic (i.e., oscillating) displacement, and N_{f} that is the number of cycles to failure of the joint 18 based on displacement of the sealant 20 are determined using FEA. C and b are material constants that are determined by the material selected for sealant 20, and are determined by analyzing laboratory test data of the material that may be selected for sealant 20 as will be described in more detail later.

More specifically, for one proposed design of joint 18 having, for example, a sealant 20, a casing 12 formed of steel, and a cover 14 formed of steel, and a predetermined number of fasteners 16, each of the maximum low cycle displacement L and the maximum high cycle displacement H can be calculated using FEA and this data stored in a database. The material of the sealant 20 and the predetermined number of fasteners 16 used for the one proposed design can remain the same during each test using FEA, while the material of the casing 12 and the material for the cover 14 can be changed. For example, in one test the material of the casing 12 can be changed from steel to aluminum and the cover 14 can remain steel; in another test the material of the casing 12 can remain steel and the material of the cover 14 can be changed to aluminum; in yet another test the material of the casing 12 can be changed to polyamide and the material of the cover 14 can remain steel, and so on. Each of these different designs can be tested using FEA over thousands (e.g., up to and even in excess of one million) cycles to determine the maximum low cycle displacement and the maximum high cycle displacement for each design of joint 18.

As noted above, the variables C and b in formula (1) are material constants of the material that is selected for sealant 20, and the values for these variables are determined by laboratory testing of the sealant material. In this regard, a laboratory test system was developed to examine the fatigue characteristics of the sealant 20 under an environment of constant oscillation with different mean displacements and high temperatures. In the below described example, the material selected for sealant 20 was a single component silicone material sold under the tradename Three Bond 1227E Alkoxy RTV-Silicone Liquid Gasket manufactured by Three Bond Europe SAS (United Kingdom).

The material selected for sealant 20 was applied to the circular planar end of a metal (e.g., steel) cylinder in a three-millimeter bead by a machine-operated application device so that accuracy and consistency of the applied bead could be obtained. Then, the circular planar end of another metal (e.g., steel) cylinder was mated with the cylinder having the seal bead formed thereon to form a joint with the sealant 20 therebetween. The cylinders were then clamped using a clamping fixture that ensured a 10 N/mm clamping force was applied to the pair of cylinders. The sealant 20 was then subjected to two-stage curing process where the sealant 20 was cured for seven days in air and then submerged for seven days in mineral oil (10W-30) to simulate a real-life application environment where sealant 20 may be exposed to oil present in an oil pan of a vehicle.

After the sealant 20 has cured, a temperature control device was attached to the clamped cylinders to heat the clamped cylinders to a temperature of, for example, 100 degrees C. Then, the clamped cylinders were subjected to tensile strains and shear strains. As noted above, the fatigue characteristics of sealant 20 were examined under an environment of constant oscillation with different mean displacements. The constant oscillations applied to the clamped cylinders during tensile strain testing had an amplitude that ranged between 10 μm and 100 μm and the mean displacements applied to the clamped cylinders during tensile strain testing ranged between 50 μm to 125 μm, for a total displacement applied during tensile strain testing that ranged between 60 μm and 225 μm. See, for example, the below Table 3.

TABLE 3
Tensile Strain Test

| Oscillation Amplitude | Mean Displacement | Total Displacement |
|---|---|---|
| (microns) | (microns) | (microns) |
| 50 | 75 | 125 |
| 30 | 75 | 105 |
| 10 | 75 | 85 |
| 50 | 50 | 100 |
| 30 | 50 | 80 |
| 10 | 50 | 60 |
| 100 | 125 | 225 |
| 75 | 125 | 200 |
| 50 | 125 | 175 |
| 30 | 50 | 80 |

Similarly, the constant oscillations applied to the clamped cylinders during shear strain testing had an amplitude that ranged between 50 μm and 300 μm and the mean displacements applied during shear strain testing ranged between 50 μm to 200 μm, for a total displacement applied during shear strain testing that ranged between 100 μm and 500 μm. See, for example, the below Table 4.

TABLE 4
Shear Strain Test

| Oscillation Amplitude | Mean Displacement | Total Displacement |
|---|---|---|
| (microns) | (microns) | (microns) |
| 50 | 50 | 100 |
| 75 | 50 | 125 |
| 100 | 50 | 150 |
| 100 | 100 | 200 |
| 150 | 100 | 250 |
| 200 | 100 | 300 |
| 150 | 150 | 300 |
| 200 | 150 | 350 |
| 250 | 150 | 400 |
| 200 | 200 | 400 |
| 300 | 200 | 500 |

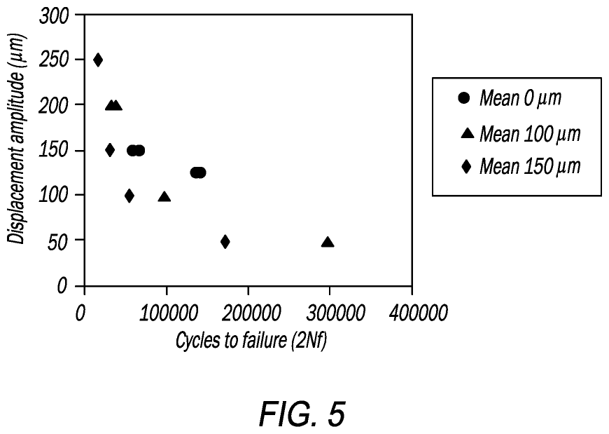

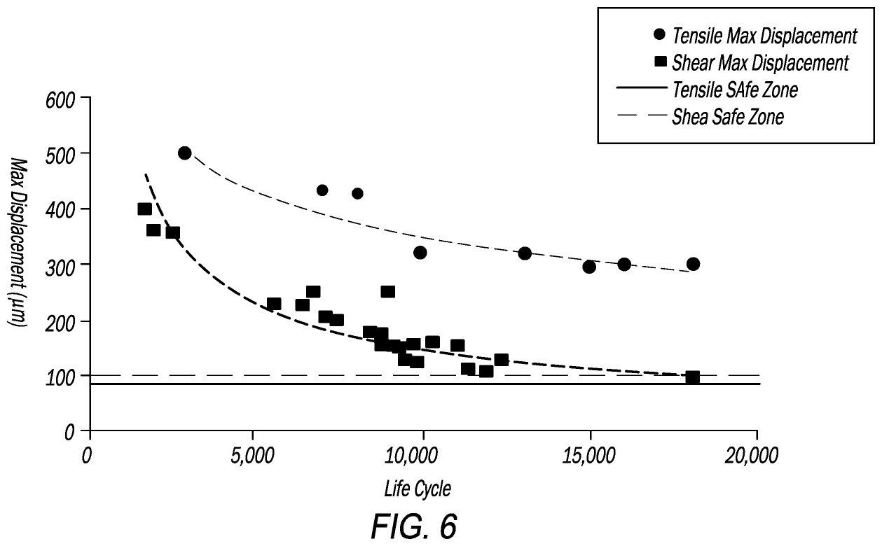

As shown in FIG. 4, in the tensile strain testing at 100 degrees C., the life cycle of the sealant 20 decreased with the increasing of displacement. Although not shown in FIG. 4, it should be noted that for a mean displacement of 75 μm and a cyclic amplitude of 10 μm the sealant 20 survived one million cycles without failure. As shown in FIG. 5, in the shear strain testing at 100 degrees C., the life cycle of the sealant 20 also decreased with the increasing of displacement. Although not shown in FIG. 5, it should be noted that for a mean displacement of 50 μm and a cyclic amplitude of 50 μm the sealant 20 survived one million cycles without failure. Thus, as shown in FIG. 6, the sealant 20 performs better in the shear direction than in the tensile direction, and the total displacement is less than 85 μm in tensile testing and 100 μm in shear testing.

As noted above in Formula (1), the present disclosure utilizes both low cycle displacements and high cycle displacements when determining whether the best design for joint 18 is used. Put another way, the present disclosure contemplates the effects of both low-cycle fatigue and high-cycle fatigue on the sealant 20 when designing joint 18.

Low-cycle fatigue is usually characterized by the Coffin-Manson relationship

$$\frac{Δ {ε}_{p}}{2} = {{ε}_{f}^{′} ( 2 {N}_{f} )}^{c} , where \frac{Δ {ε}_{p}}{2}$$

is the plastic strain amplitude; 2N_{f} is the number of cycles to failure; ε_{f}′ is an empirical constant known as the fatigue ductility coefficient (i.e., the failure strain for a single cycle); and c is an empirical constant known as the fatigue ductility exponent.

High-cycle fatigue is usually characterized by Basquin's equation of

$$\frac{Δ {ε}_{e}}{2} = \frac{{σ}_{f}^{′}}{E} {( 2 {N}_{f} )}^{b} , where \frac{Δ {ε}_{e}}{2}$$

is the elastic strain amplitude; σ_{f}′ is the fatigue strength coefficient; E is the modulus of elasticity; 2N_{f} is the number of cycles to failure; and b is the fatigue strength exponent.

Morrow's design rule combines the elastic strain and the plastic strain into a total strain relationship as follows:

$$\frac{Δ {ε}_{t}}{2} = \frac{{σ}_{f}^{′}}{E} {( 2 {N}_{f} )}^{b} + {{ε}_{f}^{′} ( 2 {N}_{f} )}^{c} .$$

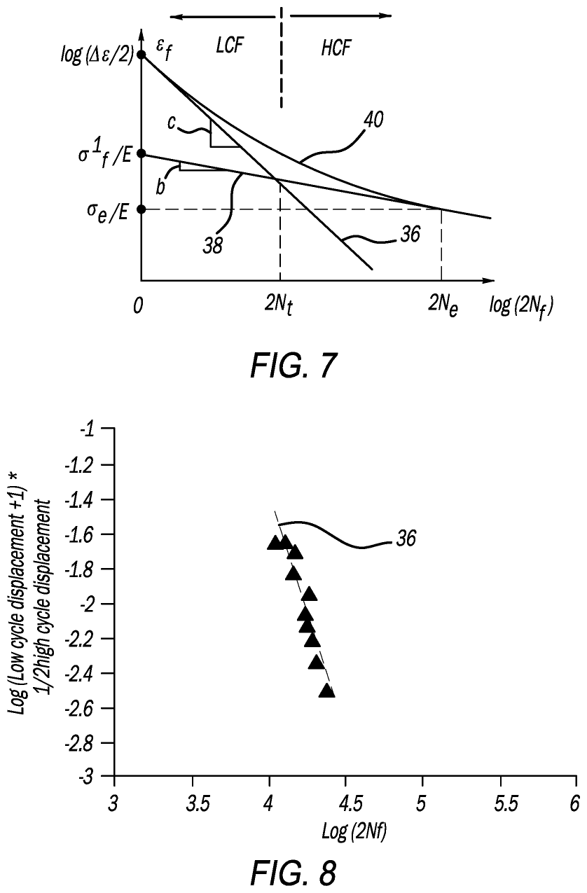

FIG. 7 illustrates the plastic, elastic, and total strain fatigue curves 36, 38, and 40, respectively. In FIG. 7, the exponents b and c are determined by the slopes of the elastic and plastic curves 38 and 36. In addition, 2Nt is the location where the plastic 36 and elastic curves 38 intersect, and represents the transition fatigue life

$$2 {N}_{t} = {( \frac{{ε}_{f}^{′} E}{{σ}_{f}^{′}} )}^{\frac{1}{b - c}} .$$

Low cycle fatigue is to the left of 2Nt and high cycle fatigue is to right of 2Nt.

While Morrow's design rule combines the elastic strain and plastic strain, it should be understood that the total strain relationship does not take mean stress (am) into consideration. Thus, Morrow's design rule must be modified to take the mean stress am into consideration:

$$\frac{Δ {ε}_{t}}{2} = \frac{{σ}_{f}^{′} - {σ}_{m}}{E} {( 2 {N}_{f} )}^{b} + {{ε}_{f}^{′} ( 2 {N}_{f} )}^{c} .$$

Alternatively, the Smith-Watson-Topper (SWT) model may be used to take mean stress (σₘₐₓ) into consideration:

$${σ}_{max} \frac{Δ ε}{2} = \frac{{( {σ}_{f}^{′} )}^{2}}{E} \cdot {( 2 {N}_{f} )}^{2 b} + {ε}_{f}^{′} {σ}_{f}^{′} \cdot {( 2 {N}_{f} )}^{b + c} .$$

In the above SWT model, due to limited experimental data, only the elastic part

$$( \frac{{( {σ}_{f}^{′} )}^{2}}{E} \cdot {( 2 {N}_{f} )}^{2 b} )$$

was plotted to find the fatigue strength exponent b. Further, in order to identify the mean displacement effect, σₘₐₓ was replaced with Amp_max, which is equivalent to a sum of the mean displacement and the oscillation amplitude (see above Tables 3 and 4): (Ampₘₐₓ)·(Amp)=C·(2N_{f})^{2b}, which is equivalent to log(Ampₘₐₓ)·(Amp)=(2b)·(log(2N_{f}))+log(C). It should be noted that C is equivalent to

$$\frac{{( {σ}_{f}^{′} )}^{2}}{E}$$

and the above equation is similar to y=mx+b, where m is 2b and defines a slope 36 (see FIG. 8).

After determining the constant C of the material that forms sealant 20 and the slope b, these values along with values associated with the maximum low cycle displacement (L) and the maximum high cycle displacement (H) can be inserted into formula (1) and the formula algebraically corrected to solve for N_{f} to determine the best design for joint 18.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for determining the predicting sealing performance of a joint having a sealant positioned between a first member and a second member, the method comprising:
selecting a sealant material for the sealant, and determining fatigue constants of the sealant by exposing the sealant to tensile strains and shear strains at an elevated temperature to simulate low-cycle loads and high-cycle loads;
selecting a first member material for the first member and a second member material for the second member;
subjecting the joint, using finite elemental analysis (FEA), to high cycle loads and low cycle loads;
after subjecting the joint to the high cycle loads and the low cycle loads, determining a maximum high cycle displacement of the joint and determining a maximum low cycle displacement of the joint; and
determining an estimated life of the joint using the following formula (1):
$$( maximum low cycle displacement + 1 ) \times ( \frac{maximum high cycle displacement}{2} ) = C \cdot {( 2 {N}_{f} )}^{2 b} ,$$
where in formula (1) C represents a constant of the sealant material;
N_{f} represents the estimated life of the joint; and
b represents a slope.

2. The method according to claim 1, wherein the high cycle loads include vibrational loads that are applied to the joint that result from operation of a vehicle including vibrations generated by an engine of the vehicle and road conditions.

3. The method according to claim 2, wherein the low cycle loads include loads applied to the joint that result from changes in temperature, changes in pressure, and abnormal acceleration and/or deceleration of the vehicle

4. The method according to claim 1, further comprising changing at least one of the first member material and the second member material to another material to form a modified joint, and subjecting the modified joint, using the FEA, to the high cycle loads and the low cycle loads.

5. The method according to claim 4, further comprising calculating a log of the product
$$( maximum low cycle displacement + 1 ) \times ( \frac{maximum high cycle displacement}{2} )$$
for each of the joint and the modified joint;
calculating a log of N_{f} for each of the joint and the modified joint, and
graphing the logs of the products versus the logs of N_{f} to determine the slope b.

6. The method according to claim 4, wherein the constant C is equivalent to
$$\frac{{( {σ}_{f}^{′} )}^{2}}{E}$$
where σ_{f}′ is a fatigue strength coefficient of the sealant and E is a modulus of elasticity of the sealant.

7. The method according to claim 1, wherein the sealant material is a one-component silicone that makes use of moisture in the atmosphere to cure the sealant or a two-component silicone that uses moisture in the atmosphere as well as a cross-linking agent such an alkoxy, acetoxy, amine, octoate, or ketoxime to cure the sealant.

8. The method according to claim 1, wherein the first member material is a metal material or a polymeric material.

9. The method according to claim 1, wherein the second member material is a metal material or a polymeric material.

10. The method according to claim 8, wherein the metal material is either steel or aluminum.

11. The method according to claim 8, wherein the polymeric material is one selected from the group consisting of polyamide, polystyrene, polypropylene, and polyethylene.

12. The method according to claim 9, wherein the metal material is either steel or aluminum.

13. The method according to claim 9, wherein the polymeric material is one selected from the group consisting of polyamide, polystyrene, polypropylene, and polyethylene.
